(19) United States
(12) Patent Application Publication
(10) Pub. No.: US 2026/0117793 A1
(43) Pub. Date: Apr. 30, 2026

(54) PORTABLE FAN

(71) Applicant: Shenzhen Jisu Technology Co., Ltd., Shenzhen City (CN)

(72) Inventors: Guanzheng ZHENG, Shenzhen City (CN); Shuiyong Yuan, Shenzhen City (CN); Jiahang Xie, Shenzhen City (CN); Xin Xiao, Shenzhen City (CN); Wenpeng Qi, Shenzhen City (CN)

(21) Appl. No.: 19/361,621

(22) Filed: Oct. 17, 2025

(30) Foreign Application Priority Data
Oct. 24, 2024 (CN) 202411487643.3

(51) Int. Cl. F04D 29/52; F04D 19/00; F04D 25/08; F04D 29/54

(52) U.S. Cl. CPC F04D 29/522; F04D 19/002; F04D 25/08; F04D 29/547

(57) ABSTRACT

This application relates to the technical field of portable heat dissipation, and provides a portable fan. This application includes a housing and a braking assembly. The housing is provided with a fixed cavity, an air inlet, and an air outlet. The air outlet includes a first air outlet and a second air outlet. The braking assembly is accommodated in the fixed cavity, and a first airflow is drawn through the air inlet by the braking assembly. The housing includes a first housing and a second housing, the first housing is provided with the first air outlet, the second housing is spaced apart from the first housing to form an air outlet channel, two ends of the air outlet channel are respectively an air suction port and the second air outlet. The air inlet, the first air outlet, the second air outlet, and the air suction port communicate with one another.

### CROSS-REFERENCE TO RELATED APPLICATION

Pursuant to 35 U.S.C. § 119 and the Paris Convention, this application claims the benefit of Chinese Patent Application No. 202411487643.3 filed Oct. 24, 2024, the contents of which are incorporated herein by reference.

### BACKGROUND

### Technical Field

The present application relates to the technical field of portable heat dissipation, in particularly to a portable fan.

### Description of Related Art

In recent years, people pursue more convenient life. To meet the need for fans in outdoor activities or other life scenarios, a variety of portable fan products have emerged on the market, such as a handheld fan, a neck hanging fan and the like.

However, while existing portable fans meet the requirement of portability, they often struggle to guarantee adequate wind force, air volume, and wind efficiency. Portable fans with weak wind force, insufficient air volume, and low wind efficiency tend to provide users with a negative experience. Therefore, it is an urgent issue that how to simultaneously satisfy both portability and excellent air outlet performance, which needs to be addressed for current portable fans.

### SUMMARY

A portable fan is provided in this application to solve the problems of small wind power, insufficient air volume and low wind effect of the existing portable fan.

In order to achieve the above object, the application adopts the following technical scheme:

In a first aspect, a portable fan is provided in the present application. The present application comprises a housing and a braking assembly.

The housing is provided with a fixed cavity, an air inlet, and an air outlet. The air outlet includes a first air outlet and a second air outlet.

The braking assembly is accommodated in the fixed cavity. A first airflow is drawn in by the braking assembly from the air inlet.

The housing includes a first housing and a second housing. The first housing is provided with the first air outlet. The second housing is spaced apart from the first housing to form an air outlet channel, and two ends of the air outlet channel are respectively an air suction port and the second air outlet. The air inlet, the first air outlet, the second air outlet, and the air suction port communicate with one another.

The first airflow is discharged from the first air outlet to the air outlet channel, so that a second airflow is attracted to flow into the air outlet channel from the air suction port to merge with the first airflow, thereby enhancing the wind force.

The beneficial effects of the portable fan of the present application are as follows: the first housing is provided with the first air outlet. The second housing is spaced apart from the first housing to form an air outlet channel, and two ends of the air outlet channel are respectively an air suction port and the second air outlet. The air inlet, the first air outlet, the second air outlet, and the air suction port communicate with one another. An air from outside the portable fan is entrained and drawn into the air inlet by the first airflow discharged out of the first air outlet. On the basis of the first airflow generated by the braking assembly, a second airflow (natural airflow) outside the fan is attracted through the air suction port to merge with the first airflow from the first air outlet to form a larger, yet equally smooth and uniform, airflow, so that the wind force and the air volume of the portable fan are effectively increased, and the user experience of using the fan is improved.

### BRIEF DESCRIPTION OF DRAWINGS

In order to clearly illustrate the technical solutions in embodiments of the present application, the following briefly describes the drawings required for describing the embodiments or the existing art. Obviously, the drawings in the following description are merely some embodiments of this application. For those skilled in the art, other drawings may be obtained based on these accompanying drawings without creative efforts.

FIG. 1 is a schematic diagram of the portable fan of the present application;

FIG. 2 is a sectional view of the portable fan of the present application;

FIG. 3 is a partially exploded view of the portable fan of the present application;

FIG. 4 is a partially sectional view of the portable fan of the present application;

FIG. 5 is a sectional view of the portable fan of the present application from another perspective;

FIG. 6 is an enlarged view of portion D in FIG. 5;

FIG. 7 is a schematic diagram of FIG. 5 from another perspective;

FIG. 8 is an enlarged view of portion C in FIG. 2; and

FIG. 9 is a section view of the braking assembly of the present application.

### DETAILED DESCRIPTION

The embodiments of the present application are described below in detail with reference to the drawings. The same or similar reference signs throughout denote the same or similar elements or elements having the same or similar functions. The embodiments described below with reference to the drawings are exemplary and are intended to explain the present application, and should not be understood as limiting the present application.

In the description of the present application, it should be understood that the orientation or positional relationship indicated by the terms that “length”, “width”, “upper”, “lower”, “front”, “rear”, “left”, “right”, “vertical”, “horizontal”, “top”, “bottom”, “inner”, “outer”, or etc. are based on the orientation or positional relationship shown in the drawings. The orientation or positional relationship indicated by the terms are merely for the convenience of describing the present application and simplifying the description, rather than indicating or implying that the apparatus or element referred to must have a specific orientation, be constructed and operated in a specific orientation. Therefore, the orientation or positional relationship indicated by the terms cannot be understood as a limitation to the present application.

In addition, the terms “first”, “second”, etc. are used herein for descriptive purposes and can not be understood as indicating or implying relative importance or implicitly indicating the number of indicated technical features. Therefore, the features defined with “first”, “second” can explicitly or implicitly include one or more of the features. In the description of the present application, the meaning of “a plurality of” is two or more, unless otherwise specifically defined.

In the present application, unless expressly specified and limited otherwise, the terms “mount”, “connect”, “connection”, “fix”, and the like should be understood in a broad sense. For example, the terms may refer to fixed connection, detachable connection, or integral connection. For another example, the terms may refer to mechanical connection or electrical connection. For another example, the terms may refer to direct connection, indirect connection through an intermediate medium, internal communication between two elements, or interaction relationship between two elements. For those of ordinary skill in the art, the specific meanings of the above terms in the present application can be understood according to specific circumstances.

In the present application, the terms “an embodiment”, “some embodiments”, “an example”, “specific example”, or “some examples” and the like mean that specific features, structures, materials or characteristics described in connection with the embodiment or example are included in at least an embodiment or example of the present application. In the present specification, schematic expressions of the above terms are not necessarily directed to the same embodiment or example. Furthermore, the specific features, structures, materials or characteristics described can be combined in a suitable manner in one or more embodiments or examples. In addition, where there is no contradiction, those skilled in the art can combine and integrate the different embodiments or examples described in the present specification, and can combine and integrate the features of the different embodiments or examples described in the present specification.

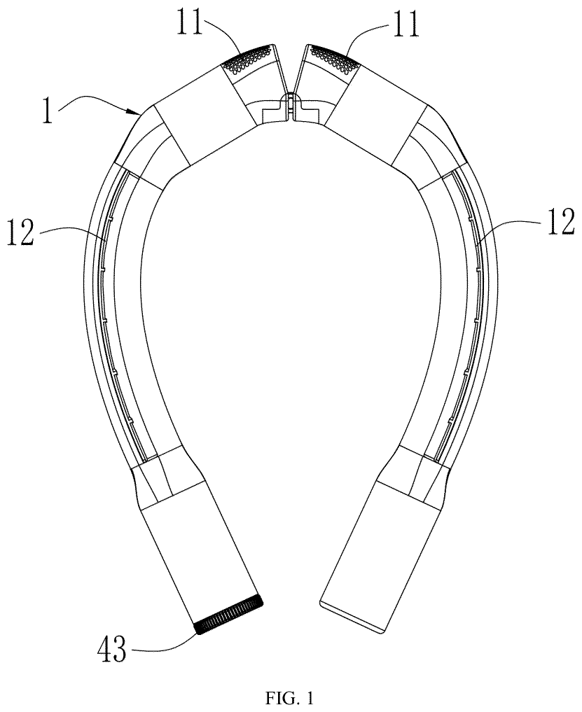

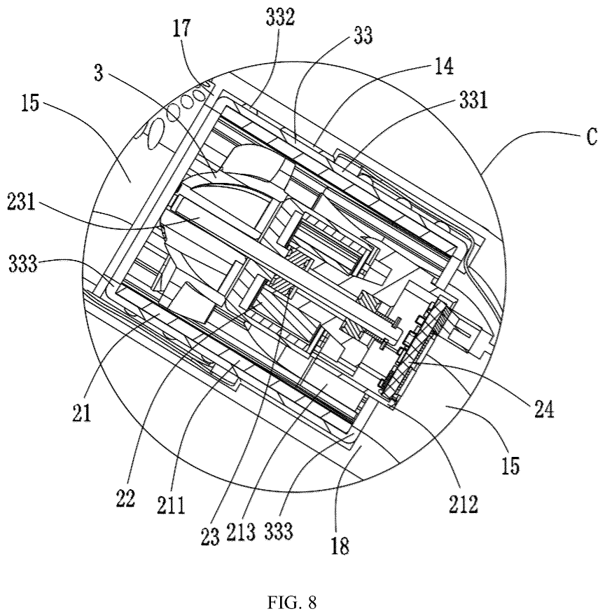

Referring to FIGS. 1-2 and 6-7, a portable fan is provided in embodiment 1 of the present application. FIGS. 1-3 show schematic diagrams of the portable fan according to the present application. The portable fan includes a housing 1 and a braking assembly 200. The housing 1 is provided with a fixed cavity 14, an air inlet 11, and an air outlet 12. The air outlet 12 includes a first air outlet 121 and a second air outlet 122. The braking assembly 200 is accommodated in the fixed cavity 14. A first airflow is drawn in by the braking assembly 200 from the air inlet 11. The housing 1 includes a first housing 110 and a second housing 120. The first housing 110 is provided with the first air outlet 121. The second housing 120 is spaced apart from the first housing 110 to form an air outlet channel 300, and two ends of the air outlet channel 300 are respectively an air suction port 1d and the second air outlet 122. The air inlet 11, the first air outlet 121, the second air outlet 122, and the air suction port 1d communicate with one another. The first airflow is discharged from the first air outlet 121 to the air outlet channel 300, so that a second airflow is attracted to flow into the air outlet channel 300 from the air suction port 1d to merge with the first airflow, thereby enhancing the wind force.

Specifically, the first housing 110 is sequentially provided with an air intake cavity 13, the fixed cavity 14, and a main air duct 15 along its length direction. The air inlet 11 is formed on the first housing 110 and communicates with the air intake cavity 13. The first air outlet 121 communicates with the main air duct 15, and the first air outlet 121 is arranged along a length direction of the main air duct 15. The braking assembly 200 is accommodated in the fixed cavity. The first airflow is drawn in by the braking assembly 200 from the air inlet 11. The first airflow then flows through the air intake cavity 13, the braking assembly 200, and the main air duct 15, and is then discharged out from the first air outlet 121.

It can be understood that the air from outside the portable fan is entrained and drawn into the air inlet by the first airflow discharged out of the first air outlet. The second housing 120 is arranged on the outer side of the first housing 110, and the second housing 120 is spaced apart from the first housing 110 to form the air outlet channel 300. One end of the air outlet channel 300 is provided with the air suction port 1d, and the air suction port 1d is arranged on one side of the first air outlet 121.

Then, on the basis of the first airflow generated by the braking assembly, the second airflow (natural airflow) outside the fan is attracted through the air inlet. The first airflow of the first air outlet and the second airflow form a larger, smooth, and uniform airflow, so that the experience of using the fan is improved.

The air suction port 1d, the first air outlet 121, and the second air outlet 122 extend in parallel, and the air suction port 1d is arranged side-by-side with the first air outlet 121 along their respective length directions, thereby the air outlet effect is improved.

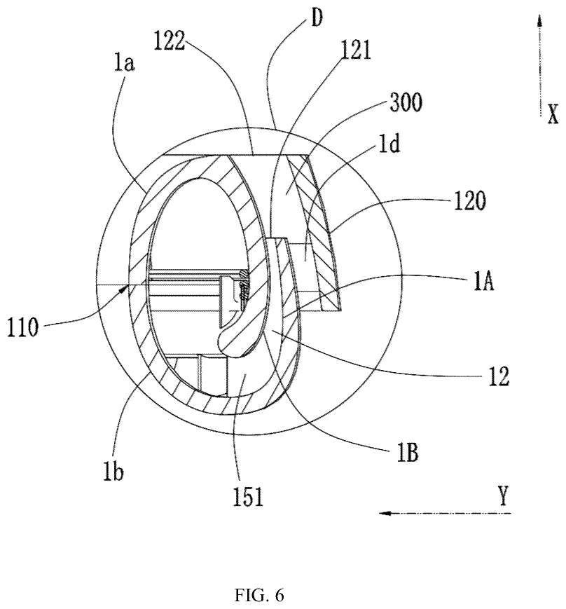

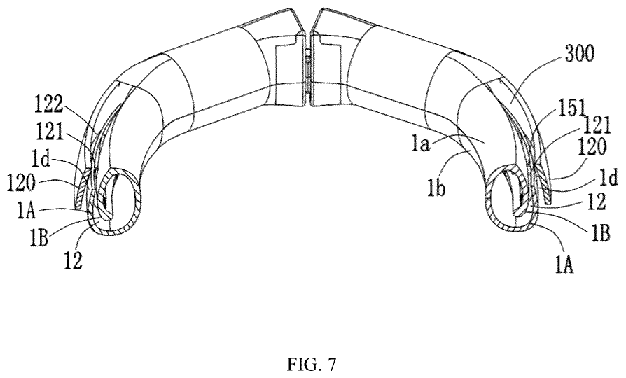

Referring to FIGS. 5 and 6, in some embodiments, the second air outlet 122 has a size larger than that of the first air outlet 121.

It can be understood that the first airflow is drawn into the air outlet channel 300 from the first air outlet 121, the second airflow is drawn into the air outlet channel 300 from the air suction port 1d. The first airflow and the second airflow merge within the air outlet channel 300, and are discharged out through the second air outlet 122 toward the user. That is, the air output volume of the second air outlet 122 is larger than that of the first air outlet 121. Consequently, the size of the second air outlet 122 is designed to be larger than that of the first air outlet 121 to adapt to the larger air output volume.

Specifically, referring to FIG. 6, a first direction X and a second direction Y perpendicular to each other are defined in a cross section which is perpendicular to the extension length direction of the housing 1. The first direction X is a height direction of the housing 1 in the cross section, and the second direction Y is a width direction of the housing 1 in the cross section. A size of the second air outlet 122 in the second direction Y is designed to be larger than a size of the first air outlet 121 in the second direction Y.

Referring to FIG. 6, in some embodiments, the second housing 120 covers the first air outlet 121.

Specifically, the second housing 120 covers the first air outlet 121 to ensure that the first airflow discharged out from the first air outlet 121 may flow into the air outlet channel 300. The air suction port 1d, defined by the second housing 120, has a substantial depth, which can increase the flow rate of the second airflow flowing into the air outlet channel 300. This enhanced flow rate allows the second housing 120 to guide the airflow more effectively.

In some other embodiments, an end of the second housing 120 and the first air outlet 121 are arranged in a same plane.

Specifically, the end of the second housing 120 is the end of the air outlet channel 300, and an end of the air outlet channel 300 close to the first air outlet 121 is arranged in the same plane as the first air outlet 121. The first airflow discharged out from the first air outlet 121 may flow into the air outlet channel 300, thereby increasing the flow merging effect.

In some other embodiments, the end of the second housing 120 is spaced apart from the first air outlet 121 along the first direction X.

Specifically, along the first direction X as indicated by an arrow, the first air outlet 121 is encountered before the end of the second housing 120. That is, the projection of the second housing 120 onto the first housing 110 falls entirely within the first wall 1a of the first housing 110, and does not fall within the second wall 1b of the first housing 110.

In the embodiment, since the size of the air outlet channel 300 defined by the second housing 120 and the first housing 110 in the second direction Y is larger than the size of the first air outlet 121 in the second direction Y, and the end of the second housing 120 may consequently be spaced apart from the first air outlet 121, the first airflow discharged out from the first air outlet 121 may still be allowed to flow into the air outlet channel 300.

Referring to FIGS. 5 to 7, in some embodiments, the first housing 110 includes a first wall 1a and a second wall 1b, the second wall 1b is closer to the second housing 120 than the first wall 1a, and the first air outlet 121 is formed between the first wall 1a and the second wall 1b.

The first housing 110 has an inner surface 1A and an outer surface 1B, the first air outlet 121 is defined by the inner surface 1A and the outer surface 1B. The inner surface 1A is spaced apart from the outer surface 1B at the first air outlet 121, is close to the outer surface 1B, or overlaps the outer surface 1B. The braking assembly is accommodated in the fixed cavity 14, and thus the portable fan is safer. The air outlet 12 is defined by the inner surface 1A and the outer surface 1B of the housing 1, so that the wind discharged out has strong wind force, and is smooth and uniform, and the user has a good experience of using the fan.

In an embodiment, as shown in FIGS. 5 to 7, at the first air outlet 121, a spacing between the inner surface 1A and the outer surface 1B ranges from 1 to 5 mm, which is conducive to the airflow being ejected from the first air outlet 121 with a strong wind force.

In some embodiments, the first wall 1a and the second wall 1b are separately formed and then assembled. A first side of the first wall 1a is connected in a closed manner to a first side of the second wall 1b, a second side of the first wall 1a is opposite to and spaced apart from a second side of the second wall 1b. The second side of the first wall 1a extends beyond the first side of the first wall 1a. The outer surface of the first wall 1a and the inner surface of the second wall 1b define the first air outlet 121.

Specifically, the first side of the first wall 1a extends in the same direction as the second side of the first wall 1a, and the first side of the second wall 1b extends in the same direction as the second side of the second wall 1b.

For example, a depth of the first air outlet 121 in the first direction is 15-23 mm. The first air outlet 121 with a proper depth can help airflow rectification to achieve effectively air outlet, thereby reducing noise and preventing turbulence.

It can be understood that, according to the shapes and the spacing of the first wall 1a and the second wall 1b, a projection of the first wall 1a in the first direction X may coincide with the second wall 1b, or the two may not coincide.

Referring to FIG. 6, in some embodiments, along the first direction, a distal end of the first wall is projected onto the second wall 1b.

It can be understood that, the projection of the first wall 1a in the first direction X may coincide with the second wall 1b, or only the distal end of the first wall 1a in the first direction X coincides with the distal end of the second wall.

In some other embodiments, along the second direction Y, there is a predetermined distance between the distal end of the first wall 1a and the distal end of the second wall 1b; that is, the projection of the first wall 1a in the first direction X does not coincide with the second wall 1b.

Referring to FIGS. 5-7, in some embodiments, the second housing 120 is at least partially spaced apart from the first wall 1a to form the air outlet channel 300, and the second housing 120 is at least partially spaced apart from the second wall 1b to form the air suction port 1d.

Specifically, the second housing 120 is sheet-shaped, the second housing 120 is arranged on the outer side of the second side of the second wall. Then, along the first direction X, the first wall 1a, the second wall 1b, and the second housing 120 are arranged in sequence and spaced apart. The second housing 120 and the first wall 1a enclose to form the air outlet channel 300. The second housing 120 and the second side of the second wall 1b enclose to form the air suction port 1d.

In another embodiment of the present application, the second housing 120 is spaced apart from the first wall 1a to form the air outlet channel 300 and the air suction port 1d.

In this embodiment, along the first direction X, the end of the second housing 120 is spaced apart from the first air outlet 121, and then the second housing 120 and the first wall 1a enclose to form the air outlet channel 300. The second housing 120 does not coincide with the first wall 1b in the second direction Y. It can be understood that a gap between the end of the second housing 120 and the second wall 1b may form the air suction port 1d.

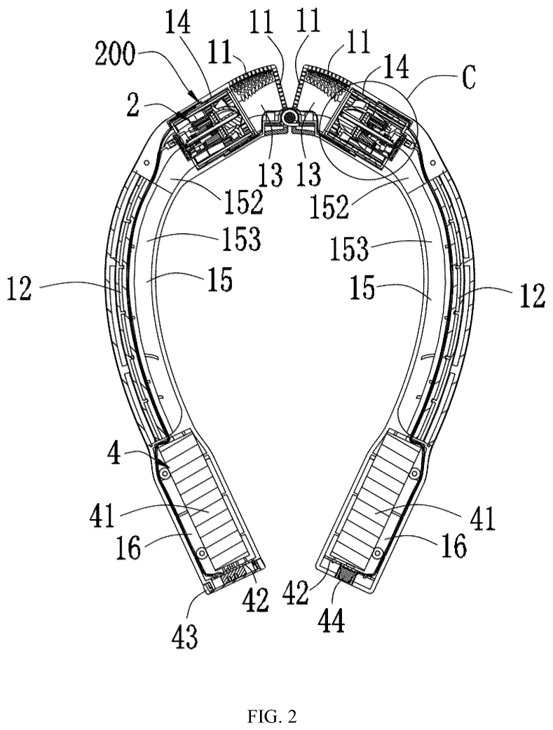

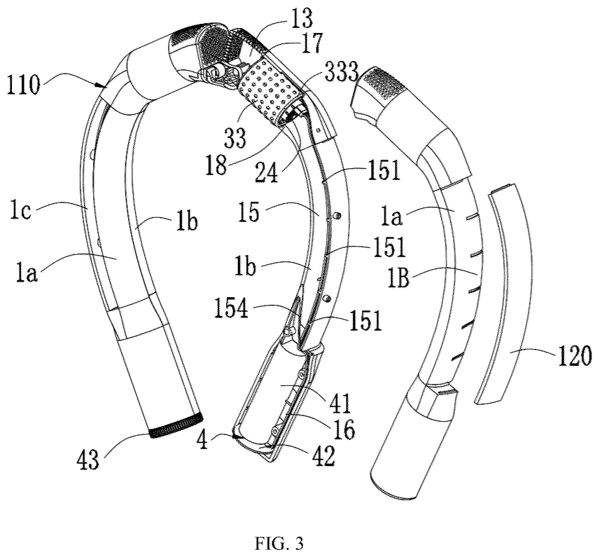

Referring to FIGS. 2 and 3, in a specific embodiment, an extension length of the second housing 120 is less than an extension length of the first wall 1a, that is, the second housing 120 and part of the first wall 1a enclose to form the air outlet channel 300, and the second housing 120 and part of the second wall 1b enclose to form the air suction port 1d.

In an embodiment, as shown in FIGS. 3, 5, 6, and 7, a spacing between the second housing 120 and the second side of the second wall 1b is 2.7-3.1 mm, and a spacing between the second housing 120 and the second side of the first wall 1a is 6.6-12.6 mm.

The air suction port 1d has a small width, so that the air passing through the air suction port 1d can be ejected out with a large wind force. The outer surface 1B of the second side of the first wall 1a is formed with a Coanda surface. The first air outlet 121 is arranged to direct airflow onto the Coanda surface.

As shown in FIGS. 3 and 5-7, in an embodiment, one side of the second housing 120 extends in the same direction as a second side of the second wall 1b does, and the one side of the second housing 120 extends beyond the second side of the second wall 1b. The other side of the second housing 120 extends in the same direction as a second side of the first wall 1a dose, and the other side of the second housing 120 does not extend beyond the second side of the first wall 1a.

The depth of the air suction port 1d is small, which facilitates the external airflow to be entrained and drawn in through the air suction port 1d by the airflow from the first air outlet 121. The one side of the second housing 120 extends beyond the second side of the second wall 1b, so that the second housing 120 can effectively guide the airflow to flow, and the airflow of the first air outlet 121 and the air suction port 1d can be smoother and more uniform.

As shown in FIGS. 3, 5 and 6, in some embodiments, a surface of the first housing is bulged to form the first air outlet, and the surface of the first housing is constructed to be arc-shaped in the extension direction of the first air outlet.

In the embodiment, the first housing 110 is bulged to form the first air outlet 121, and the first air outlet 121 is a slit-type air outlet 2 arranged on the surface of the first housing 110. The slit-type air outlet 2 may be one of a plurality of slit-type air outlets 2. The plurality of slit-type air outlets 2 are continuous or spaced apart from each other.

The direction of the first air outlet 121 may be upward toward the user's face, or downward toward the user's shoulder and neck.

Specifically, a surface corresponding to the housing in the extension direction of the first air outlet 121 is constructed to be arc-shaped. The arc shape of the corresponding surface of the first housing 1 may be formed by natural bending and extension of the first housing 1, or may be formed by a protrusion or recess on the surface of the first housing 1. The bending direction of the arc shape may be curved below the first air outlet 121, or may extend above the first air outlet 121, with the specific bending direction constructed according to usage requirements.

According to the Coanda effect of the fluid, when an arc surface appears in the flow path of the airflow discharged out from the first air outlet 121, the airflow may move directionally along the arc surface. The airflow moving directionally may make the airflow discharged out by the first air outlet 121 have stronger directionality, and the directional movement can also help concentrate the airflow, thereby improving the efficiency of the blowing process. Additionally, since the first air outlet 121 is arranged on the surface of the first housing 110 and constructed as a protrusion, it can prevent the first air outlet 121 from being blocked by the user's skin, thereby ensuring higher air outlet efficiency and stability.

In some embodiments, the first air outlet 121 is enclosed by the first wall 1a and the second wall 1b. The second wall 1b is formed on the first housing 110 and protrudes. The first wall 1a extends and bends toward the inside of the first housing 110.

As shown in FIGS. 1-3 and 5, in some embodiments, the main air duct 15 includes a first air constriction section 152 and a second air constriction section 153 sequentially arranged along the length direction. The first air constriction section 152 is arranged adjacent to the fixed cavity 14, the first air constriction section 152 has a part with a reduced cross section relative to the fixed cavity 14, and the second air constriction section 153 has a part with a reduced cross section relative to the first air constriction section 152. By arranging the first air constriction section 152 and the second air constriction section 153 with the parts with the reduced cross sections, the air pressure is increased, the maximum air delivery distance is extended, and the air outlet range is expanded, so that the air is uniformly supplied at each position of the air outlet 12. Furthermore, the first constriction segment 152 and the second constriction segment 153, with their cross-sectional areas decreasing along the length direction, enable the airflow to move smoothly toward the air outlet 12 and reduce noise.

The length of the first air constriction section 152 is less than the length of the second air constriction section 153. The length of the second air constriction section 153 is 2-8 times the length of the first air constriction section 152. The first air constriction section 152 is a main air constriction zone, located close to the fixed cavity 14. The first air constriction section 152 pressurizes and converges the air generated by the braking assembly. However, the length of the first air constriction section 152 should not be too long, otherwise the air pressure is too large to supply air, and the noise is too strong.

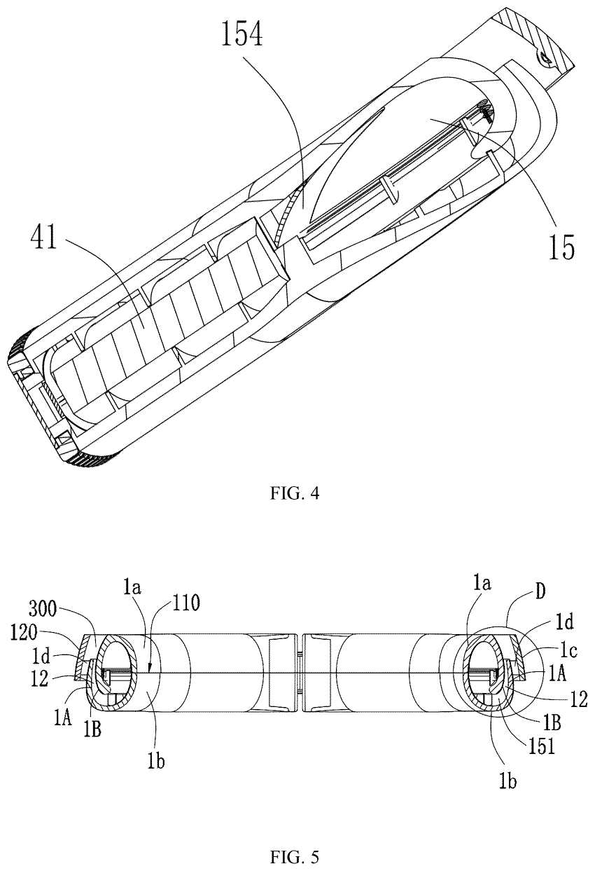

In an embodiment, as shown in FIGS. 3 and 4, the second air constriction section 153 includes an air converging component 154 arranged at an end of the second air constriction section 153 away from the braking assembly. The air converging component 154 is configured for reducing the cross section. Furthermore, in a direction away from the braking assembly 200, the air converging component 154 reduces the cross section of the second air constriction section 153 to an increasingly greater extent. At the end of the second air constriction section 153 away from the braking assembly 200, the air volume of the part relatively close to the braking assembly 200 is reduced due to the increased distance from the braking assembly 200, and the air output volume and the air delivery distance are easily affected. By arranging the air converging component 154, the air is pressurized, resulting in uniform airflow.

It should be understood that the arrangement of the air converging component 154 in the second air constriction section 153 embodies the characteristic that the cross section of the second air constriction section 153 is reduced relative to that of the first air constriction section 152. Additionally, in other embodiments, other air converging structures may be arranged at other positions of the second air constriction section 153 to further ensure uniform airflow across each part of the air outlet 12.

In an embodiment, as shown in FIGS. 1, 2, 5, and 7, the first air outlet 121 is arranged in the second air constriction section 153, and the first air outlet 121 runs through the entire section of the second air constriction section 153.

An inner surface 1A of the first wall 1a and an inner surface 1A of the second wall 1b define the second air constriction section 153. The first air outlet 121 runs through the entire section of the second air constriction section 153, so that the second air constriction section 153 has a considerable length, the corresponding first air outlet 121 also has a considerable length, resulting in a large air outlet range.

As shown in FIGS. 3 and 5-7, in some embodiments, the portable fan further includes an air guide member 151. The air guide member 151 is connected to at least one of an outer surface 1B of the first wall and an inner surface 1A of the second wall.

Specifically, the portable fan further includes a plurality of air guide members 151. The plurality of air guide members 151 are arranged at intervals along the length direction of the main air duct 15, and are used for guiding the first airflow generated by the braking assembly 200 to blow towards the first air outlet 121. Each air guide member 151 simultaneously abuts against the first wall 1a and the second wall 1b. By providing the air guide members 151, the airflow is rectified and guided, thereby reducing noise and avoiding turbulence. It should be understood that there is a spacing between the outer surface 1B of the first wall 1a and the inner surface 1A of the second wall 1b, and the first air outlet 121 may be defined by the spacing. Alternatively, there is no spacing between at least a part of the outer surface 1B of the first wall 1a and at least a part of the inner surface 1A of the second wall 1b, i.e. there is an overlapping relationship between the two surfaces. The air guide member 151 is configured to pushed apart an overlapping portion so as to define and form the first air outlet 121. In the embodiment, the outer surface 1B of the first wall 1a is provided with a plurality of grooves (not labeled, the same as the following grooves). The air guide member 151 is arranged to abut against the corresponding grooves.

In an embodiment, as shown in FIGS. 1-3, the maximum cross-sectional area of the main air duct 15 is smaller than the minimum cross-sectional area of the air intake cavity 13. The maximum cross-sectional area of the fixed cavity 14 is smaller than or equal to the minimum cross-sectional area of the air intake cavity 1. The minimum cross-sectional area of the fixed cavity 14 is larger than or equal to the maximum cross-sectional area of the main air duct 15. The cross-sectional areas of the air intake chamber 13, the fixed chamber 14, and the main air duct 15 decrease in sequence along the length direction. Each adjacent pair of the three components including the air intake cavity 13, the fixed cavity 14, and the main air duct 15 have a smooth transition between them. The air intake cavity 13 is short in length but large in cross-section, which is conducive to air suction and flow guide, thereby increasing the air inlet volume. Furthermore, the provision of the air intake cavity 13 effectively prevents the turbulence and noise that result from direct contact between the external airflow and the braking assembly. The main air duct 15 is small in cross-section, the wind generated by the braking assembly is pressurized and converged in the main air duct 15, so that the air outlet effect can be enhanced. The main air duct 15 is long in length, so that the air outlet range is increased, and the user's experience of using the fan is improved.

Specifically, the length of the air intake cavity 13 is 20-30 mm, and the length of the main air duct 15 is 2-6 times the length of the air intake cavity 13.

In an embodiment, as shown in FIGS. 1-3, a portion of the first housing part 110 provided with the fixed chamber 14 is cylindrical. The diameter of the portion of the first housing part 110 provided with the fixed chamber 14 is 28-35 mm. The length of the portion of the first housing part 110 provided with the fixed chamber 14 is 30-40 mm. The diameter of fixed cavity 14 is small, thus the overall cross-section of the first housing 110 may be small, so that the neck-hanging fan is relatively slender and symmetrical, and is convenient to carry. The length of the fixed chamber 14 is also relatively short, which allows the length of the corresponding main air duct 15, through which the air is discharged, to be configured more rationally.

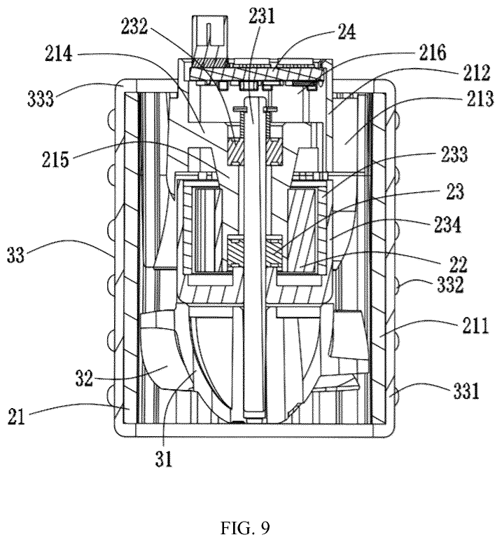

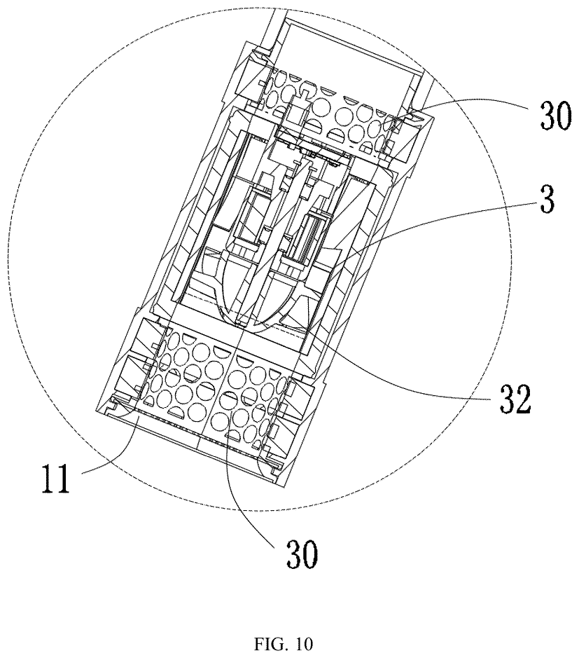

In an embodiment, as shown in FIGS. 2, 3, 8, and 9, the braking assembly 200 includes a motor 2 and a blower 3. The motor 2 includes a cylinder 21, a stator assembly 22, and a rotor assembly 23. The motor 2 is a high-speed three-phase motor, which can provide a high and stable rotational speed, thereby improving the air outlet effect. At least part of the blower 3 is arranged in the cylinder 21. In the embodiment, the entire blower 3 is arranged in the cylinder 21, resulting in a compact and rational structure for the braking assembly, as well as a short length for the cavity it occupies.

In an embodiment, the motor 2 is a high-speed three-phase motor with a rotational speed range of 15,000-41,000 rpm, an operating voltage of 3V-6V, an operating current of 0.25 A-8 A, and a rated power of 1 W-10 W. This parameter configuration helps to mitigate the noise associated with high-speed operation, and to make the wind speed and air volume appropriate for a scenario of using the portable fan.

In an embodiment, as shown in FIGS. 2, 3, 8, 9, the braking assembly 200 further includes a buffer sleeve 33 arranged outside the cylinder 21. The buffer sleeve 33 includes an annular portion 331 and a plurality of protrusion portion 332 spaced around the outer surface 1B of the annular portion 331. When the braking assembly 200 is accommodated in the fixed cavity 14, at least part of the plurality of protrusion portion 332 is compressed, thereby securely fixing the braking assembly 200 within the fixed chamber 14. The buffer sleeve 33 provides high friction as well as buffering and shock-absorbing capabilities for the braking assembly 200, thus effectively reducing the noise generated by the braking assembly 200.

In an embodiment, as shown in FIGS. 2-3 and 8-9, a first limiting portion 17 is arranged between the fixed cavity 14 and the air intake cavity 13, a second limiting portion 18 is arranged between the fixed cavity 14 and the main air duct 15, and the first limiting portion 17 and the second limiting portion 18 collectively restrict the braking assembly 200. The buffer sleeve 33 further includes a wrapping component 333 connected to its two ends. The wrapping component 333 at one end isolates and buffers the end of the cylinder 21 from the first limiting portion 17, and the wrapping component 333 at the other end isolates and buffers the end of the cylinder 21 from the second limiting portion 18. The wrapping component 333 further provides the braking assembly 200 with buffering and damping capacity, and further reduces the noise generated by the braking assembly 200. In addition, the cooperation of the first limiting portion 17, the second limiting portion 18, and the wrapping components 333 at the two ends further restricts axial movement of the braking assembly 200. This results in the braking assembly 200 being securely and stably fixed within the fixed chamber 14, thereby allowing it to generate airflow steadily and continuously with low noise. The material of the buffer sleeve 33 may be silicone, foam or other materials with buffering capacity, and the examples given are not exhaustive. In other embodiments, the braking assembly 200 may not be provided with the buffer sleeve 33.

In an embodiment, as shown in FIGS. 2-6, the inner wall of the first air constriction section 152 extends from the free edge of the second limiting portion 18 toward the second air constriction section 153. The cross-sectional area of the first air constriction section 152 gradually decreases along the length direction away from the braking assembly. The first air constriction section 152 starts from the second limiting portion 18 and provides a smooth transition, which is conducive to reducing the vortex flow formed due to the decreasing cross-sectional area, enables smooth airflow toward the second air constriction section 153, and reduces noise. In other embodiments, the inner wall of the first air constriction section 152 may not extend from the free edge of the second limiting portion 18 toward the second air constriction section 153, as long as the inner wall of the first air constriction section 152 smoothly transitions, the airflow flows smoothly, and the noise is reduced.

In an embodiment, as shown in FIGS. 2, 3, 8 and 9, the cylinder 21 includes an outer ring portion 211, an inner ring portion 212, and a plurality of connecting blades 213 connecting the outer ring portion 211 and the inner ring portion 212. The inner ring portion 212 is arranged on the side of the outer ring portion 211 close to the main air duct 15 slightly protrudes toward the main air duct 15. This arrangement provides more space on the side of the outer ring portion 211 facing the air intake cavity 13 for arranging other components, resulting in a rational spatial layout within the cylinder 21. A base plate 214 is provided in the inner ring portion 212, and a hollow shaft tube 215 extends axially from the base plate 214 toward the air intake cavity 13. The rotor assembly 23 includes a rotating shaft 231, bearings 232, and a magnetic ring 233. The rotating shaft 231 and at least one bearing 232 are arranged in the shaft tube 215. In this embodiment, two bearings 232 are provided, and both bearings 232 are arranged in the shaft tube 215. One of the two bearings 232 may be arranged in the shaft tube 215 while the other may be arranged outside the shaft tube 215, as long as the stable cooperation between the rotating shaft 231 and the shaft tube 215 is ensured. The stator assembly 22 is arranged on the radial outer side of the rotating shaft 231 and the shaft tube 215, and the magnetic ring 233 is arranged on the radial outer side of the stator assembly 22. The blower 3 is arranged on the side of the outer ring portion 211 close to the air intake cavity 13, and the blower 3 is fixed on the rotating shaft 231.

In an embodiment, as shown in FIGS. 2, 3, 8 and 9, the rotor assembly 23 further includes a casing 234. The casing 234 is sleeved outside the magnetic ring 233, and the casing 234 is tightly matched with the rotating shaft 231. The blower 3 is fixed on the rotating shaft 231. The blower 3 and the motor 2 are coaxially arranged, and the blower 3 and the casing 234 are coaxially arranged. When the stator assembly 22 generates a magnetic field, it causes the magnetic ring 233 and the casing 234 to rotate, and the casing 234 drives the rotating shaft 231 and the blower 3 to rotate simultaneously. Thus, no additional transmission device is required between the motor 2 and the blower 3, effectively improving the power transmission efficiency of the neck hung fan.

In an embodiment, as shown in FIGS. 2, 3, 8 and 9, the blower 3 includes a hub 31 and a plurality of blades 32 spaced around the outside of the hub 31. The difference between any two of three diameters which including the diameter of the maximum cross-sectional of the hub 31, the diameter of the casing 234, and the diameter of the inner ring portion 212 is less than 2 mm. The airflow generated by the plurality of blades 32 can flow smoothly into the air duct 15 through the area between the casing 234 and the outer ring portion 211, as well as the area between the inner ring portion 212 and the outer ring portion 211. The hub 31, the casing 234, and the inner ring portion 212 are axially arranged and have similar diameters, resulting in a compact structure for the motor 2 and the blower 3.

Referring to FIG. 10, in some embodiments, at least two silencing device 30 are provided within the first housing 110. At least one silencing device 30 is arranged between the air inlet 11 and the braking assembly 200, and at least one other silencing device 30 is arranged between the braking assembly 200 and the first air outlet 121.

Specifically, the air inlet 11 and the blower 3 corresponding to the air inlet 11 are provided within the first housing 110. Each blower 3 is provided with two silencing device 30. One silencing device 30 is arranged between the first air inlet 202 and the blower 3, and the other silencing device 30 is arranged between the blower 3 and the first air outlet 121.

In some other embodiments, two silencing device 30 are arranged between the first air inlet 202 and the blower 3. Another silencing device 30 may be arranged between the blower 3 and the first air outlet 121. The sound attenuation device 30 may also be provided in multiple numbers, and the corresponding arrangement position and number may be adjusted as required.

It can be understood that the specific number of the silencing device 30, the distance between the silencing device 30 and the blower, or the specific shape and structure of the silencing device 30 may be adjusted based on the noise level and requirements.

In an embodiment, as shown in FIGS. 2, 3, 8 and 9, the inner ring portion 212 defines a reception component 216 on a side of the base plate 214 facing the main air duct 15.

A driving board 24 is arranged in the reception component 216 and is electrically connected to the control member 42. The reception component 216 is directly formed by the inner ring portion 212, that is, the driving board 24 is directly arranged in the inner ring portion 212 and faces the main air duct 15, thereby facilitating the connection of the driving board 24 with other electrical elements. The base plate 214 is also provided with a notch. A wire is electrically connected with the stator assembly 22 and the driving board 24 via the notch.

In an embodiment, as shown in FIGS. 2, 3, 8 and 9, both free ends of the housing 1 are each provided with an accommodating cavity 16. The portable fan further includes a control assembly. The control assembly includes a power supply member 41 for providing power for the braking assembly 200 and a control component 42 for controlling the braking assembly 200. The power supply member 41 is electrically connected with the control component 42, and the control component 42 is electrically connected with the driving board 24. The power supply member 41 and the control component 42 are accommodated in the accommodating cavity 16. The control member 42 includes a switch 43 and an interface 44 exposed outside the free end of the housing 1.

In a second embodiment of the present application, a portable fan is provided. The portable fan includes a housing 1. The housing 1 is provided with an air inlet 11 and an air outlet 12, the air outlet 12 includes a first air outlet 121 and a second air outlet 122. The housing 1 includes a first housing 110 and a second housing 120, and the first housing 110 is spaced apart from the second housing 120 to form an air outlet channel 300. The first housing includes a first wall 1a and a second wall 1b, the first air outlet 121 is formed between the first wall 1a and the second wall 1b, the second air outlet 122 is formed between the second housing 120 and the first wall 1a. An air suction port 1d is formed between the second housing 120 and the second wall 1b. The air inlet 11, the first air outlet 11, the second air outlet 122, and the air suction port 1d communicate with one another.

It is to be understood that, in the embodiment, the air intake cavity 13, the fixed cavity 14, the main air duct 15, and the accommodating cavity 16 are sequentially arranged along the length direction of the housing 1. In other embodiments, the air intake cavity 13, the fixed cavity 14, and the main air duct 15 may also be sequentially arranged along the length direction of the housing 1. The accommodating cavity 16 may be arranged on one side of the air intake cavity 13 or on one side of the main air duct 15.

In a third embodiment of the present application, a portable fan is provided. The portable fan includes a housing 1 and a braking assembly 200. The housing 1 is provided with a fixed cavity 14, an air inlet 11, and an air outlet 12, and the air outlet 12 includes a first air outlet 121. The braking assembly 200 is accommodated in the fixed cavity 14, and a first airflow is drawn in by the braking assembly 14 from the air inlet 11. The housing 1 includes a neck portion and a hanging portion connected to two ends of the neck portion. The housing 1 includes a first housing 110, the first housing 110 is located at the hanging portion, and the first housing 110 includes a first wall 1a and a second wall 1b. Along a first direction, a distal end of the first wall 1a is projected onto the second wall 1b. Alternatively, along a second direction, the end of the first wall 1a and a distal end of the second wall 1b are projected at a predetermined distance. The first direction and the second direction are perpendicular. The first airflow flows from the air inlet to the first air outlet.

In the embodiment, as shown in FIGS. 1 to 5, the portable fan is a neck hung fan. The neck portion of the portable fan is configured for hanging around a user's neck, and the hanging portion extends forward along both sides of the user's neck.

Referring to FIGS. 1 and 2, in some embodiments, the housing 1 is symmetrically provided with two air inlet cavities 13, two fixed cavities 14 and two main air ducts 15. The two braking assemblies are respectively arranged in the two fixed cavities 14. When the fan is worn with the second air outlet 122 facing upwards, the airflow generated by the braking assembly 200 blows towards the user's head. Drawing in air through the air suction port 1d accelerates air movement around the neck, thereby promoting sweat evaporation. Alternatively, when the fan is worn with the second air outlet 122 facing downwards, the airflow in the braking assembly 200 blows towards the user's neck, and the air drawn in through the air suction port 1d accelerates air movement around the head, thereby promoting sweat absorption. In other embodiments, the portable fan may also be a handheld fan, a clip-on fan, a versatile fan, and the like, and the examples given are not exhaustive.

In some other embodiments, the neck hung fan includes a housing 1, a braking assembly 200, and a control assembly. The housing 1 may be provided with four fixed cavities 14, the air intake cavity 13 and the main air duct 15. The air intake cavity 13 and the main air duct 15 are provided at both ends of each fixed cavity 14. Each air intake cavity 13 is provided with the air inlet 11, and each air duct 15 is provided with the air outlet 12. The neck hung fan is provided with four braking assemblies 200, with one braking assembly arranged in each fixed chamber 14. Each braking assembly 200 draws in a first airflow from the corresponding air inlet 11, and discharges out the first airflow from the corresponding first air outlet 121 via the corresponding air intake cavity 13, braking assembly 200, and main air duct 15.

The foregoing descriptions are merely preferred embodiments of the present application and are not intended to limit the present application. Any modifications, equivalent substitutions, and improvements made within the spirit and principles of the present application shall fall within the protection scope of the present application.

What is claimed is:

1. A portable fan, comprising:
a housing, provided with a fixed cavity, an air inlet, and an air outlet, wherein the air outlet comprises a first air outlet and a second air outlet; and
a braking assembly, accommodated in the fixed cavity, wherein the braking assembly draws in a first airflow from the air inlet;
wherein
the housing comprises a first housing and a second housing, the first housing is provided with the first air outlet, the second housing is spaced apart from the first housing to form an air outlet channel, two ends of the air outlet channel are respectively an air suction port and the second air outlet, and the air inlet, the first air outlet, the second air outlet, and the air suction port communicate with one another; and
the first airflow is discharged from the first air outlet to the air outlet channel, so that a second airflow is attracted to flow into the air outlet channel from the air suction port to merge with the first airflow, thereby enhancing a wind force.

2. The portable fan of claim 1, wherein a size of the second air outlet is larger than a size of the first air outlet.

3. The portable fan of claim 1, wherein
the second housing covers the first air outlet; or,
an end of the second housing and the first air outlet are arranged in a same plane; or
the end of the second housing and the first air outlet are spaced apart along a first direction.

4. The portable fan of claim 1, wherein the first housing comprises a first wall and a second wall, the second wall is closer to the second housing than the first wall, and the first air outlet is formed between the first wall and the second wall.

5. The portable fan of claim 4, wherein
a distal end of the first wall is projected onto the second wall along a first direction; or
a projection of the distal end of the first wall and a projection of a distal end of the second wall have a predetermined distance along a second direction, and the first direction and the second direction are perpendicular.

6. The portable fan of claim 4, wherein
the second housing is at least partially spaced apart from the first wall to form the air outlet channel, and the second housing is at least partially spaced apart from the second wall to form the air suction port; or
the second housing is spaced apart from the first wall to form the air outlet channel and the air suction port.

7. The portable fan of claim 4, further comprising:
an air guide member, connected to at least one of an outer surface of the first wall and an inner surface of the second wall.

8. The portable fan of claim 4, wherein a first side of the first wall is connected in a closed manner to a first side of the second wall, a second side of the first wall is opposite to and spaced apart from a second side of the second wall, the second side of the first wall extends beyond the first side of the first wall, and the second side of the second wall extends beyond the first side of the second wall.

9. The portable fan of claim 6, wherein
the second housing is constructed as a sheet, one side of the second housing and a second side of the second wall extend in the same direction, and the one side of the second housing extends beyond the second side of the second wall; and
the other side of the second housing and a second side of the first wall extend in the same direction, and the other side of the second housing does not extend beyond the second side of the first wall.

10. The portable fan of claim 8, wherein a spacing between the second housing and the second side of the second wall is 2.7-3.1 mm, and a spacing between the second housing and the second side of the first wall is 6.6-12.6 mm.

11. The portable fan of claim 4, wherein a first side of the first wall is connected in a closed manner to a first side of the second wall, a second side of the first wall is opposite to and spaced apart from a second side of the second wall, an outer surface of the second side of the first wall is formed with a Coanda surface, and the first air outlet is arranged to direct airflow onto the Coanda surface.

12. The portable fan of claim 4, wherein the first housing is sequentially provided with an air intake cavity, the fixed cavity and a main air duct along its length direction; the air inlet is formed on the first housing and communicates with the air intake cavity; the first air outlet communicates with the main air duct, and the first air outlet is arranged along a length direction of the main air duct; and the first airflow is drawn in through the air inlet by the braking assembly, guided through the air intake cavity, the braking assembly, and the main air duct, and is then discharged from the first air outlet.

13. The portable fan of claim 12, wherein
the main air duct comprises a first air constriction section and a second air constriction section sequentially arranged along the length direction, the first air constriction section is arranged adjacent to the fixed cavity, the first air constriction section has a part with a reduced cross section relative to the fixed cavity, and the second air constriction section has a part with a reduced cross section relative to the first air constriction section; and
the first air outlet is arranged in the second air constriction section, an inner surface of the first wall and an inner surface of the second wall define the second air constriction section, and an outer surface of the first wall and the inner surface of the second wall define the first air outlet.

14. The portable fan of claim 13, wherein the second air constriction section comprises an air converging component arranged at an end of the second air constriction section away from the braking assembly, the air converging component is configured for reducing the cross section, and a degree of a reduction in the cross section of the second air constriction section by the air converging component increases in a direction away from the braking assembly.

15. The portable fan of claim 12, wherein a maximum cross-sectional area of the main air duct is smaller than a minimum cross-sectional area of the air intake cavity, a maximum cross-sectional area of the fixed cavity is smaller than or equal to the minimum cross-sectional area of the air intake cavity, and a minimum cross-sectional area of the fixed cavity is larger than or equal to the maximum cross-sectional area of the main air duct.

16. The portable fan according to claim 1, wherein at least two silencing devices are arranged in the first housing, at least one of the two silencing devices is arranged between the first air inlet and the braking assembly, and at least another of the two silencing devices is arranged between the braking assembly and the first air outlet.

17. The portable fan of claim 1, wherein a surface of the first housing is bulged to form the first air outlet, and the surface of the first housing is constructed to be arc-shaped in an extension direction of the first air outlet.

18. A portable fan, comprising a housing, provided with an air inlet and an air outlet, wherein
the air outlet comprises a first air outlet and a second air outlet, the housing comprises a first housing and a second housing, and the first housing is spaced apart from the second housing to form an air outlet channel;
the first housing comprises a first wall and a second wall, the first air outlet is formed between the first wall and the second wall, and the second air outlet is formed between the second housing and the first wall; and
an air suction port is formed between the second housing and the second wall, and the air inlet, the first air outlet, the second air outlet, and the air suction port communicate with one another.

19. A portable fan, comprising:
a housing, provided with a fixed cavity, an air inlet, and an air outlet, wherein the air outlet comprises a first air outlet; and
a braking assembly, accommodated in the fixed cavity, wherein a first airflow is drawn in by the braking assembly from the air inlet;
wherein
the housing comprises a neck portion and a hanging portion connected to two ends of the neck portion, the housing comprises a first housing, the first housing is located at the hanging portion, the first housing comprises a first wall and a second wall;
a distal end of the first wall is projected onto the second wall along a first direction; or
wherein a projection of the distal end of the first wall and a projection of a distal end of the second wall have a predetermined distance along a second direction, and the first direction and the second direction are perpendicular; and
the first airflow flows from the air inlet to the first air outlet.

20. The portable fan of claim 19, wherein
the air outlet further comprises a second air outlet, the housing further comprises a second housing, the first housing is spaced apart from the second housing to form an air outlet channel, the second air outlet is formed between the second housing and the first wall, and an air suction port is formed between the second housing and the second wall, wherein the air inlet, the first air outlet, the second air outlet, and the air suction port communicate with one another; and
the first airflow is discharged from the first air outlet to the air outlet channel, so that a second airflow is attracted to flow into the air outlet channel from the air suction port, and merge with the first airflow, thereby enhancing a wind force.
